(19) United States
(12) Patent Application Publication
(10) Pub. No.: US 2026/0340864 A1
(43) Pub. Date: Oct. 29, 2026

(54) METHOD AND APPARATUS FOR PREDICTING PHYSICAL WORKLOAD IN THREE-DIMENSIONAL SPACE FROM MONOCULAR IMAGE

(71) Applicants: HYUNDAI MOTOR COMPANY, Seoul (KR); Kia Corporation, Seoul (KR)

(72) Inventor: Hotaek HAN, Hwaseong-si (KR)

(21) Appl. No.: 19/384,630

(22) Filed: Nov. 10, 2025

(30) Foreign Application Priority Data
Apr. 25, 2025 (KR) 10-2025-0054858

(51) Int. Cl. G06T 7/73; G06T 7/62; G06V 10/25

(52) U.S. Cl. CPC G06T 7/73; G06T 7/62; G06V 10/25; G06V 2201/07

(57) ABSTRACT

A method for predicting physical workload in a three-dimensional space from a monocular image according to an embodiment includes: determining 2D pose information of a human from monocular image data for the human’s body, determining 3D pose information of the human from the 2D pose information, correcting the 3D pose information based on the idle state of the human, and predicting the physical workload of the human based on a joint angle for at least one joint in the body determined from the corrected 3D pose information.

### CROSS-REFERENCE TO RELATED APPLICATION

Pursuant to 35 U.S.C. § 119(a), this application claims the benefit of an earlier filing date and right of priority to Korean Patent Application No. 10-2025-0054858 filed in the Republic of Korea on Apr. 25, 2025, the entire contents of which are hereby expressly incorporated herein by reference into the present application.

### BACKGROUND

The present disclosure relates to a method and apparatus for predicting physical workload in three-dimensional space from a monocular image. Measuring a worker’s physical workload is required in various industrial, medical, and sports settings. Methods for assessing physical load can include obtaining physiological measurements, such as electromyography (EMG), heart rate (HR), and oxygen consumption (VO₂) measurements.

### SUMMARY

According to one aspect, there is provided a method for predicting physical workload in a three-dimensional space from a monocular image includes: determining 2D pose information of a human from monocular image data including the human’s body, determining 3D pose information of the human from the 2D pose information, correcting the 3D pose information based on the idle state of the human, and predicting the physical workload of the human based on a joint angle for at least one joint included in the body determined from a corrected 3D pose information.

In some implementations, determining the 2D pose information of the human can include: determining detection information on the position and size of the human from the monocular image data using an object detection module, and determining 2D pose information of the human from the detection information on the position and size of the human using a pre-trained 2D pose estimation module.

In some implementations, determining the detection information on the position and size of the human can include: determining the probability that the human exists in at least one anchor box preset from the monocular image data, determining a bounding box regarding the position and size of the human from at least one preset anchor box, with reference to the probability that the human is present, and determining patch image data for the human based on the bounding box.

In some implementations, determining the 2D pose information of the human can include: determining 2D position coordinates of keypoints for at least one joint included in the body from the patch image data.

In some implementations, determining the 2D position coordinates of keypoints for at least one joint included in the body can include: generating a heat map indicating the probability of the keypoint being present within the patch image data, and determining the position coordinates at which the keypoint has the highest probability of being present as the 2D position coordinates of the keypoint, with reference to the heat map.

In some implementations, the pre-trained 2D pose estimation module can be trained using a second training dataset that is reconstructed by sampling on a first training dataset based on principal component analysis of the first training dataset including ground-truth 2D position coordinates of the keypoints.

In some implementations, determining the 3D pose information of the human can include: determining the 3D pose information of the human from the 2D pose information of the human using a pre-trained 3D pose estimation module.

In some implementations, the pre-trained 3D pose estimation module can be trained using a third training dataset that includes ground-truth 3D position coordinates of the keypoint mapped to the ground-truth 2D position coordinates of the keypoint. Correcting the 3D pose information can include: correcting the 3D position coordinates of the keypoint included in the 3D pose information, with reference to an offset determined from a reference keypoint for at least one joint corresponding to the idle state of the human.

In some implementations, predicting the physical workload of the human can include: calculating a joint angle for at least one joint from the 3D position coordinates of the corrected keypoint, and predicting the physical workload, with reference to the musculoskeletal load corresponding to the joint angle for at least one joint. Calculating the joint angle from the 3D position coordinates of the corrected keypoint can include: determining a plurality of vectors regarding at least one joint from the 3D position coordinates of the corrected keypoint, and determining the joint angle by using a cosine distance for the plurality of vectors.

According to another aspect, an apparatus for predicting physical workload in a three-dimensional space from a monocular image includes: a memory in which a physical workload prediction program is stored, and a processor configured to load the physical workload prediction program from the memory and to execute the physical workload prediction program to perform operations that include: determining 2D pose information of a human from monocular image data including the human’s body, determining 3D pose information of the human from the 2D pose information, correcting the 3D pose information based on the idle state of the human, and predicting the physical workload of the human based on a joint angle for at least one joint included in the body determined from the corrected 3D pose information.

In some implementations, processor can be configured to perform further operations that include: determining detection information based on the position and size of the human from the monocular image data using an object detection module, and determining 2D pose information of the human from the detection information on the position and size of the human using a pre-trained 2D pose estimation module.

In some implementations, the processor can be configured to perform further operations that include: determining a probability that the human exists in at least one anchor box preset from the monocular image data, determing a bounding box regarding the position and size of the human from at least one preset anchor box, with reference to the probability that the human is present, and determining patch image data for the human based on the bounding box.

In some implementations, the processor can be configured to perform further operations that include: determining 2D position coordinates of the keypoints for at least one joint included in the body from the patch image data.

In some implementations, the processor can be configured to perform further operations that include: generating a heat map indicating the probability of the keypoint being present within the patch image data, and determining the position coordinates at which the keypoint has the highest probability of being present as the 2D position coordinates of the keypoint, with reference to the heat map.

In some implementations, the processor can be configured to perform further operations that include: determining the 3D pose information of the human from the 2D pose information of the human using a pre-trained 3D pose estimation module.

In some implementations, the processor can be configured to perform further operations that include: correcting the 3D position coordinates of the keypoint included in the 3D pose information, with reference to an offset determined from a reference keypoint for at least one joint corresponding to the idle state of the human.

In some implementations, the processor can be configured to perform further operations that include: calculating a joint angle for at least one joint from the 3D position coordinates of the corrected keypoint, and predicting the physical workload of the human, with reference to the musculoskeletal load corresponding to the joint angle for at least one joint.

In some implementations, the processor can be configured to perform further operations that include: determining a plurality of vectors regarding at least one joint from the 3D position coordinates of the corrected keypoint, and determining the joint angle by using the cosine distance for the plurality of vectors.

According to another aspect, there is provided a computer program stored in a computer-readable recording medium that includes instructions for predicting physical workload that, when executed by a processor, cause the processor to perform operations that include: determining 2D pose information of a human from monocular image data including the human’s body, determining 3D pose information of the human from the 2D pose information, correcting the 3D pose information based on the idle state of the human, and predicting the physical workload of the human based on a joint angle for at least one joint included in the body determined from the corrected 3D pose information.

### BRIEF DESCRIPTION OF THE DRAWINGS

FIG. 1 is a block diagram illustrating an apparatus for predicting physical workload.

FIG. 2 is a block diagram conceptually illustrating the function of a physical workload prediction program.

FIG. 3 is a flowchart illustrating a method for predicting physical workload in a three-dimensional space from a monocular image.

FIG. 4 exemplarily illustrates predicting physical workload in three-dimensional space from a monocular image.

FIG. 5 exemplarily illustrates determining 2D position coordinates of keypoints for at least one joint based on detection information according.

FIG. 6 exemplarily illustrates determining the physical workload, with reference to a joint angle calculated based on correction for 3D pose information.

FIG. 7 exemplarily illustrates determining an idle state of a human.

### DETAILED DESCRIPTION

Measuring a worker’s physical workload is essential in many industrial, medical, and sports settings.

Alternative techniques typically assess physical load by using physiological measurements such as electromyography (EMG), heart rate (HR), and oxygen consumption (VO₂). However, obtaining these physiological measurements often requires wearable sensors, which can cause discomfort when worn for long periods of time. Additionally, the measurement values obtained by a wearable sensor can vary depending on changes in the position of the wearable sensor.

Non-contact workload measurement methods using computer vision and artificial intelligence technologies can also be used. For example, a non-contact method can evaluate the musculoskeletal load by analyzing a worker's pose using CCTV or a portable camera. However, although such methods can overcome the limitations of the wearable sensors, they can often provide inaccurate results due to the lack of depth information for three-dimensional pose estimation.

Depth information-based 3D pose estimation methods utilize stereo cameras or depth sensors, but typically require high computational and hardware costs.

For example, utilizing two stereo cameras requires synchronizing and precisely calibrating the two cameras to extract depth information. Additionally, depth sensors can perform poorly in certain lighting environments and require very large computational resources for high-resolution data processing, which can limit their use in real-time operation.

Implementations disclosed herein can provide systems and techniques that can predict the physical workload based on the 3D pose of the worker estimated from monocular images using a lightweight module based on deep learning to improve the accuracy, real-time, and computational efficiency of physical workload prediction without the need for separate sensors, specialized equipment, or motion capture systems.

Implementations of the present disclosure can provide a system and method for predicting physical workload in a 3D space in real time using a lightweight module based on deep learning from a monocular image captured by a single camera, which can improve cost efficiency.

Implementations of the present disclosure can improve the prediction accuracy of the 3D pose determined from a 2D image by compensating for the depth error by performing a correction to the 3D pose based on the idle pose of the human maintained for a predetermined period of time.

Implementations of the present disclosure can use a lightweight 2D pose estimation module to process a monocular image captured by a single camera to predict physical workload in a 3D space in real time, which can improve cost efficiency.

Further, by training the 2D pose estimation module using a training dataset that includes an even distribution of various poses and is not biased toward a specific pose, implementations of the present disclosure can improve the inference performance of the lightweight 2D pose estimation module.

Additionally, by correcting 3D pose information using an offset determined from the reference keypoint based on a reference frame, implementations of the present disclosure can reduce a depth error from converting the 2D pose information into the 3D pose information.

Implementations, features, and advantages of the present disclosure are not limited to those mentioned above and additional other implementations, features, and advantages will be clearly understood by those skilled in the art from the detailed description and the accompanying drawings.

The above and other implementations, features, and advantages of the present disclosure will become apparent from the detailed description of the following example implementations in conjunction with the accompanying drawings.

It should be understood that the present disclosure is not limited to the following implementations and can be implemented in different ways, and that the example implementations are provided for complete disclosure and thorough understanding of the disclosure by those skilled in the art.

In describing implementations of the present disclosure, if it is determined that a detailed description of a known function or configuration might unnecessarily obscure the gist of the present disclosure, the detailed description will be omitted. The terms described below are terms defined in consideration of functions in implementations of the present disclosure, and can vary depending on the intention or custom of the user or operator.

Therefore, the definitions should be based on the contents throughout the present specification.

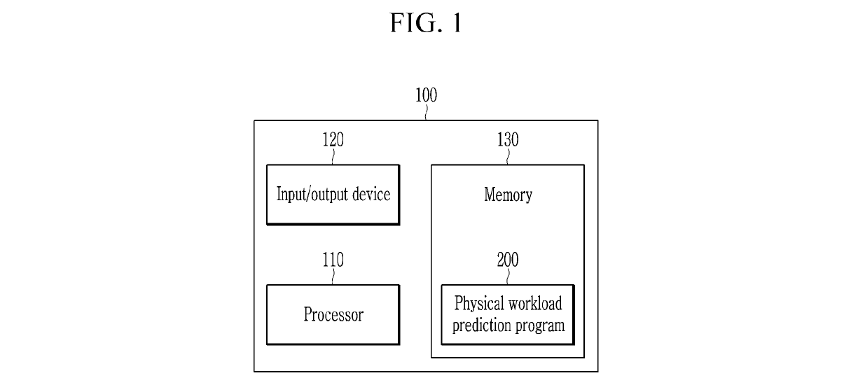

FIG. 1 is a block diagram illustrating an apparatus 100 for predicting physical workload.

Referring to FIG. 1, the apparatus 100 for predicting physical workload can include a processor 110, an input/output device 120, and a memory 130. The processor 110 can control the overall operation of the apparatus 100 for predicting physical workload.

The processor 110 can receive monocular image data including a human’s body using the input/output device 120.

Specifically, the processor 110 can receive monocular image data including the human’s body acquired using a monocular camera or image data including at least one frame for the human’s body.

In the present specification, for convenience of description, it is stated that at least one of monocular image data including the human’s body and image data including at least one frame for the human’s body is input through the input/output device 120, but it is not limited thereto.

That is, in some implementations, the apparatus 100 for predicting physical workload can include a transceiver (not shown), and the apparatus 100 for predicting physical workload can receive at least one of monocular image data including the human’s body and image data including at least one frame for the human’s body by using the transceiver (not shown), and at least one of monocular image data including the human’s body and image data including at least one frame for the human’s body can be collected or generated within the apparatus 100 for predicting physical workload.

The processor 110 can determine 3D pose information of the human from monocular image data including the human’s body, correct the 3D pose information based on the idle state of the human, and predict the physical workload of the human based on a joint angle for at least one joint included in the body determined from the corrected 3D pose information.

The input/output device 120 can include one or more input devices and/or one or more output devices. For example, input devices can include a microphone, a keyboard, a mouse, a touch screen, etc., and output devices can include a display, a speaker, etc.

The memory 130 can store a physical workload prediction program 200 and information necessary for executing the physical workload prediction program 200.

In this specification, the physical workload prediction program 200 can refer to software including instructions for determining 2D pose information of the human from monocular image data including the human’s body, determining 3D pose information of the human from the 2D pose information, correcting the 3D pose information of the human based on the idle state of the human, and predicting the physical workload of the human based on a joint angle for at least one joint included in the body determined from the corrected 3D pose information.

The processor 110 can load the physical workload prediction program 200 and information necessary for executing the physical workload prediction program 200 from the memory 130 to execute the physical workload prediction program 200.

The processor 110 can determine detection information on the position and size of the human from the monocular image data including the human’s body, determine 2D position coordinates of keypoints for at least one joint included in the body using the detection information, correct 3D position coordinates of the keypoint mapped to the 2D position coordinates of the keypoint, and predict physical workload of the human from a joint angle for at least one joint calculated from the 3D position coordinates of the corrected keypoint.

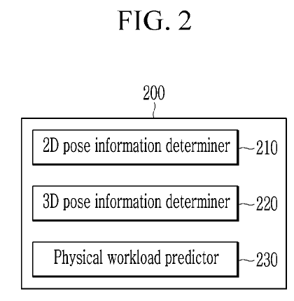

The function and/or operation of the physical workload prediction program 200 will be described in detail with reference to FIG. 2.

FIG. 2 is a block diagram conceptually illustrating the function of the physical workload prediction program.

Referring to FIG. 2, the physical workload prediction program 200 can include a 2D pose information determiner 210, a 3D pose information determiner 220, and a physical workload predictor 230.

The 2D pose information determiner 210, the 3D pose information determiner 220, and the physical workload predictor 230 shown in FIG. 2 are conceptually divided into functions of the physical workload prediction program 200 to easily describe the functions of the physical workload prediction program 200, but are not limited thereto. In some implementations, the functions of the 2D pose information determiner 210, the 3D pose information determiner 220, and the physical workload predictor 230 can be merged/separated and implemented as a series of instructions included in one program.

First, the 2D pose information determiner 210 can determine 2D pose information of the human from the monocular image data including the human’s body.

Here, the monocular image data refers to data regarding a monocular image captured from a single camera, and can mean 2D image data.

Specifically, the 2D pose information determiner 210 can determine detection information on the position and size of the human from the monocular image data using an object detection module (e.g., Faster R-CNN, SSD, YOLO model, etc.).

More specifically, the 2D pose information determiner 210 can determine the probability that the human exists in at least one anchor box preset from the monocular image data.

In some implementations, the 2D pose information determiner 210 can determine probabilities that the human exists in multiple preset anchor boxes. The multiple preset anchor boxes can have different sizes and ratios. For example, the object detection module can dispose multiple anchor boxes at each location in the monocular image data.

In addition, the 2D pose information determiner 210 can determine a bounding box regarding the position and size of the human from at least one preset anchor box, with reference to the probability of the human being present.

Here, there can be multiple anchor boxes within the detected body of the human, and the 2D pose information determiner 210 can determine the bounding box using the inference result of the anchor box with the highest existence probability based on post-processing (e.g., post-processing using a non-maximum suppression (NMS) algorithm) on the probability of existence in at least one anchor box.

Additionally, the 2D pose information determiner 210 can determine patch image data for the human based on the bounding box.

For example, the 2D pose information determiner 210 can determine the patch image data by cropping the monocular image data so that only the human body region included within the bounding box is extracted.

On the other hand, the 2D pose information determiner 210 can determine 2D pose information of the human from detection information on the position and size of the human using a pre-trained 2D pose estimation module.

Here, the 2D pose information of the human can refer to information representing a pose of the human based on 2D position coordinates for the human’s body parts.

Specifically, the 2D pose information determiner 210 can determine the 2D position coordinates of the keypoint for at least one joint included in the body from the patch image data.

For example, the 2D pose information determiner 210 can determine the 2D position coordinates of the keypoint for at least one predefined joint (e.g., knee, pelvis, shoulder, etc.) within the patch image data.

More specifically, the 2D pose information determiner 210 can generate a heat map (i.e., a probability distribution map) indicating the probability that the keypoint for at least one joint exists in the patch image data using a pre-trained 2D pose estimation module.

In some implementations, the heat map can be set to have the highest probability at a specific point using a Gaussian distribution.

In addition, the 2D pose information determiner 210 can determine the position coordinates at which the keypoint has the highest probability of existing as the 2D position coordinates of the keypoint, with reference to the heat map.

The 2D pose estimation module can be a lightweight module that is trained using the second training dataset that is reconstructed by sampling on the first training dataset based on principal component analysis (PCA) of the first training dataset including ground-truth 2D position coordinates of the keypoint.

In this regard, the 2D pose estimation module can convert the ground-truth 2D position coordinates of all keypoints included in the first training dataset into a first pose feature vector.

For example, if the ground-truth 2D position coordinates of the shoulder are (5, 12) and the ground-truth 2D position coordinates of the knee are (13, 42), the 2D pose estimation module can convert the ground-truth 2D position coordinates into a four-dimensional first pose feature vector (5, 12, 13, 42).

Additionally, the 2D pose estimation module can apply principal component analysis to the first pose feature vector to determine a first eigen vector corresponding to the direction with the greatest change in the first training dataset.

For example, the 2D pose estimation module can determine the first principal component with the largest dispersion for the first pose feature vector as the first eigen vector.

Additionally, the 2D pose estimation module can determine a projective pose feature having a 1D scalar value by projecting the first pose feature vector onto the first eigen vector. Additionally, by sampling from the distribution of projective pose features, the second training dataset can be determined.

For example, the 2D pose estimation module can discretize the distribution by generating a histogram based on the distribution of 1D projective pose features. Next, the 2D pose estimation module can construct the second training dataset by performing uniform sampling in each bin of the histogram.

Training the 2D pose estimation module using the second training dataset reconstructed from the first training dataset, in which various poses are evenly distributed and not biased toward a specific pose, can improve the inference performance of the lightweight 2D pose estimation module.

Next, the 3D pose information determiner 220 can determine 3D pose information of the human from the 2D pose information.

Here, the 3D pose information of the human can refer to information representing a pose of the human based on 3D position coordinates of body parts of the human.

Specifically, the 3D pose information determiner 220 can determine 3D pose information of the human from 2D pose information of the human using the pre-trained 3D pose estimation module.

Here, the 3D pose estimation module can be trained using a third training dataset including ground-truth 3D position coordinates of the keypoint mapped to ground-truth 2D position coordinates of the keypoint.

More specifically, the 3D pose information determiner 220 can input the 2D position coordinates of the keypoints for all frames inferred through the 2D pose estimation module into the 3D pose estimation module to determine the 3D position coordinates of the keypoints.

On the other hand, the 3D pose information determiner 220 can correct the 3D pose information based on the idle state of the human.

Here, the idle state of the human can refer to a state in which the human maintains an idle pose for a predetermined period of time, and the idle state of the human can be determined as follows using the 3D pose estimation module.

Specifically, the 3D pose estimation module can determine a second pose feature vector from the 3D position coordinates of the keypoints for all of the frames.

Additionally, the 3D pose estimation module can apply principal component analysis to the second pose feature vector to determine the first eigen vector corresponding to the direction with the greatest change.

For example, the 3D pose estimation module can determine the first principal component with the largest dispersion for the second pose feature vector as the first eigen vector.

Additionally, the 3D pose estimation module can determine a projective pose feature having a 1D scalar value by projecting the second pose feature vector onto the first eigen vector. The 3D position coordinates of N keypoints with the lowest values among the distributions of the projective pose features can be determined.

In addition, the 3D pose estimation module can determine a frame defined based on the average value of the 3D position coordinates for the N keypoints as a reference frame, and can define a state corresponding to the reference frame as the idle state.

On the other hand, the 3D pose information determiner 220 can correct the 3D position coordinates of the keypoint included in the 3D pose information, with reference to an offset determined from the reference keypoint for at least one joint corresponding to the idle state of the human.

Here, the reference keypoint can refer to a keypoint for at least one joint determined in the reference frame. Additionally, the offset can refer to the difference between the 3D position coordinates of the reference keypoint and the 3D position coordinates of another keypoint in the reference frame.

For example, when setting the neck included in the body as the reference keypoint, the 3D pose estimation module can determine and store the difference between the 3D position coordinates of the neck (e.g., (0, 1.5, 0)) and the 3D position coordinates of the shoulder (e.g., (0, 1.6, -0.1)) in the reference frame as an offset (e.g., (0, -0.1, 0.1)).

As such correcting 3D pose information through an offset determined from the reference keypoint based on the reference frame can reduce a depth error that occurs when 2D pose information is converted into 3D pose information.

Next, the physical workload predictor 230 can predict the physical workload based on the joint angle of at least one joint included in the body determined from the corrected 3D pose information.

Specifically, the physical workload predictor 230 can calculate a joint angle for at least one joint from the 3D position coordinates of the corrected keypoint.

More specifically, the physical workload predictor 230 can determine a plurality of vectors regarding at least one joint from the 3D position coordinates of the corrected keypoint.

Additionally, the physical workload predictor 230 can determine the joint angle by using a cosine distance for the plurality of vectors.

For example, in the case of a joint angle for the elbow, the physical workload predictor 230 can determine a first vector using the 3D position coordinates of the shoulder and the 3D position coordinates of the elbow, and can determine a second vector using the 3D position coordinates of the elbow and the 3D position coordinates of the wrist.

Additionally, the physical workload predictor 230 can determine the angle between the first vector and the second vector using the cosine distance as the joint angle.

Next, the physical workload predictor 230 can predict the physical workload of the human, with reference to the musculoskeletal load corresponding to at least one joint angle.

In some implementations, the physical workload predictor 230 can determine the musculoskeletal load corresponding to the joint angle using a rapid upper limb assessment (RULA) technique.

Here, the RULA technique can refer to a technique for quickly assessing the workload caused by work pose by focusing on the upper limbs such as the shoulder, wrist, and neck.

For example, the physical workload predictor 230 can determine the musculoskeletal load for the neck based on the joint angle for the neck.

Here, the musculoskeletal load can be determined as 1 point when the joint angle for the neck is between 0 and 10 degrees, 2 points when it is between 10 and 20 degrees, 3 points when it is between 20 and 45 degrees, and 4 points when it is 45 degrees or more.

Additionally, the physical workload predictor 230 can determine the physical workload based on the average of the musculoskeletal load for at least one joint.

On the other hand, the physical workload predictor 230 can determine whether the physical workload of the human exceeds a predetermined threshold value. If the physical workload exceeds the predetermined threshold value, the physical workload predictor 230 can provide a notification to the user (or work environment manager).

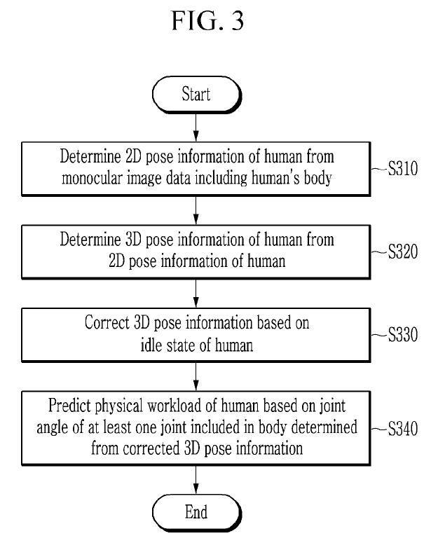

FIG. 3 is a flowchart illustrating a method for predicting physical workload in a three-dimensional space from a monocular image.

Referring to FIG. 3, the 2D pose information determiner 210 can determine 2D pose information of the human from monocular image data including the human’s body (S310).

Next, the 3D pose information determiner 220 can determine 3D pose information of the human from the 2D pose information (S320).

Next, the 3D pose information determiner 220 can correct the 3D pose information based on the idle state of the human (S330).

Next, the physical workload predictor 230 can predict the physical workload of the human based on the joint angle of at least one joint included in the body determined from the corrected 3D pose information (S340).

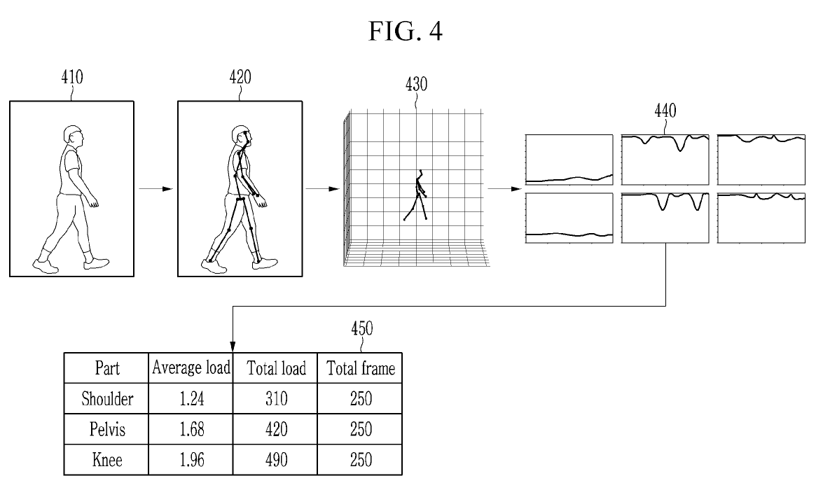

FIG. 4 exemplarily illustrates predicting a physical workload in three-dimensional space from the monocular image.

Referring to FIG. 4, the apparatus 100 for predicting physical workload can obtain the monocular image data including at least one frame including the human’s body (410).

Next, the apparatus 100 for predicting physical workload can determine 2D position coordinates of the keypoints for at least one predefined joint from the monocular image data using the object detection module and the 2D pose estimation module (420).

Next, the apparatus 100 for predicting physical workload can determine the 3D position coordinates of the keypoint mapped to the 2D position coordinates of the keypoint using the 3D pose estimation module (430).

Here, the 3D position coordinates of the keypoint can be corrected with reference to an offset determined from at least one reference keypoint corresponding to the idle state of the human.

Next, the apparatus 100 for predicting physical workload can calculate a joint angle for at least one joint from the 3D position coordinates of the corrected keypoint using a joint angle calculation module (440).

Next, the apparatus 100 for predicting physical workload can determine the physical workload from at least one joint angle using a workload calculation module (450). Here, the physical workload can be determined as the average of the skeletal muscle load for at least one joint.

That is, the apparatus 100 for predicting physical workload can determine the average value (i.e., 1.62) for the skeletal muscle load for the shoulder (i.e., 1.24), the skeletal muscle load for the pelvis (i.e., 1.68), and the skeletal muscle load for the knee (i.e., 1.96) as the physical workload.

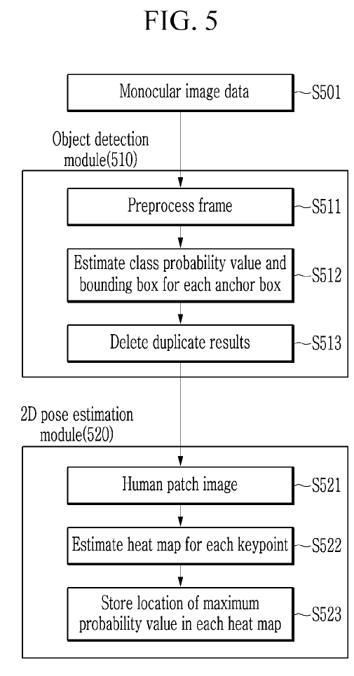

FIG. 5 exemplarily illustrates determining 2D position coordinates of keypoints for at least one joint based on detection information.

Referring to FIG. 5, the apparatus 100 for predicting physical workload can receive monocular image data including the human’s body performing a predetermined work or action (S501).

Next, the apparatus 100 for predicting physical workload can pre-process all frames included in the monocular image data using an object detection module 510 (S511).

Next, the apparatus 100 for predicting physical workload can estimate the class probability value (i.e., the probability value that a human exists) and the bounding box for each anchor box from all of the pre-processed frames (S512).

Next, the apparatus 100 for predicting physical workload can delete duplicate anchor boxes or bounding boxes based on post-processing using a non-maximum suppression (NMS) algorithm (S513). Here, the apparatus 100 for predicting physical workload can determine patch image data from which a human region is extracted based on an anchor box or bounding box that has not been deleted.

Next, the apparatus 100 for predicting physical workload can receive patch image data from which the human region is extracted using a 2D pose estimation module 520 (S521).

Next, the apparatus 100 for predicting physical workload can estimate a heat map for each keypoint for at least one joint from the patch image data (S522).

Next, the apparatus 100 for predicting physical workload can store the location of the maximum probability value in each heat map (S523).

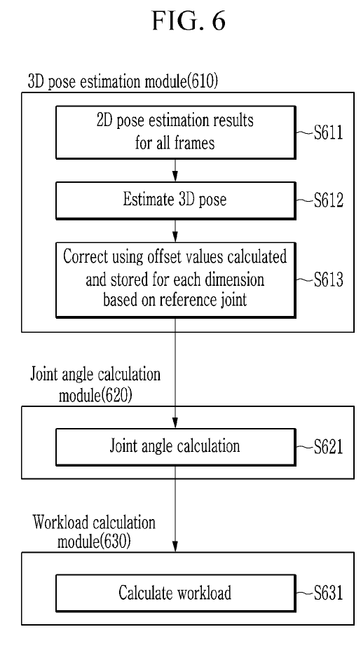

FIG. 6 exemplarily illustrates determining the physical workload, with reference to a joint angle calculated based on correction for 3D pose information.

Referring to FIG. 6, the apparatus 100 for predicting physical workload can input 2D pose estimation results for all frames into a 3D pose estimation module 610 (S611).

Next, the apparatus 100 for predicting physical workload can estimate the 3D pose using the 3D pose estimation module 610 (S612).

Next, the apparatus 100 for predicting physical workload can correct the estimated 3D pose using the offset values calculated and stored for each dimension based on the reference joint (S613).

Next, the apparatus 100 for predicting physical workload can calculate joint angles for at least one joint from the corrected 3D pose using a joint angle calculation module 620 (S621).

Next, the apparatus 100 for predicting physical workload can calculate the physical workload, with reference to the skeletal muscle load corresponding to the joint angle using a workload calculation module 630 (S631).

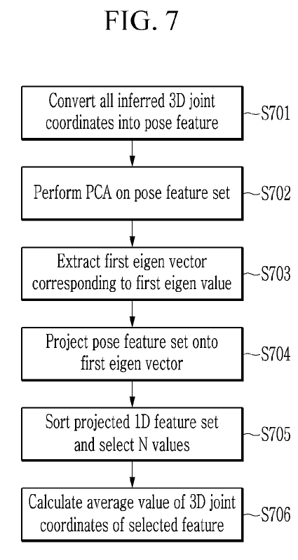

FIG. 7 exemplarily illustrates determining an idle state of the human.

Referring to FIG. 7, the apparatus 100 for predicting physical workload can convert the 3D position coordinates of all inferred joints using the 3D pose estimation module into the pose feature vector (S701).

Next, the apparatus 100 for predicting physical workload can apply principal component analysis to the pose feature vector (S702).

Next, the apparatus 100 for predicting physical workload can extract the first eigen vector corresponding to a first eigen value (S703).

Next, the apparatus 100 for predicting physical workload can project the pose feature vector onto the first eigen vector (S704).

Next, the apparatus 100 for predicting physical workload can sort the 1D projection pose features and select N values through sampling (S705).

Next, the apparatus 100 for predicting physical workload can determine the reference frame by calculating the average value of the 3D position coordinates of the selected keypoints (S706).

Here, the apparatus 100 for predicting physical workload can define a state corresponding to the reference frame as the idle state.

Combinations of each step in respective blocks of block diagrams and a flowchart attached herein can be carried out by computer program instructions. Since the computer program instructions can be loaded in processors of a general-purpose computer, a special-purpose computer, or other programmable data processing apparatus, the instructions, when carried out by the processor of the computer or other programmable data processing apparatus, create devices for performing functions described in the respective blocks of the block diagrams or in the respective steps of the sequence diagram. Since the computer program instructions, in order to implement functions in a specific manner, can be stored in a memory useable or readable by a computer directed to a computer or other programmable data processing apparatus, the instructions stored in the memory useable or readable by a computer can produce manufacturing items including an instruction device for performing functions described in the respective blocks of the block diagrams and in the respective steps of the sequence diagram. Since the computer program instructions can be loaded in a computer or other programmable data processing apparatus, instructions, a series of processing steps of which is executed in a computer or other programmable data processing apparatus to create processes executed by a computer so as to operate a computer or other programmable data processing apparatus, can provide steps for executing functions described in the respective blocks of the block diagrams and the respective sequences of the sequence diagram.

Moreover, the respective blocks or the respective sequences can indicate modules, segments, or portions of code including at least one executable instruction for executing a specific logical function(s). It should be noted that in some implementations, the functions described in the blocks or the sequences can run out of the above described order. For example, two successive blocks and sequences can be substantially executed simultaneously or often in reverse order according to corresponding functions.

The above description is merely an example of the technical idea of the present disclosure, and those skilled in the art would appreciate that various modifications and variations can be made without departing from the essential quality of the present disclosure. Therefore, the implementations disclosed in the present disclosure are not intended to limit the technical idea of the present disclosure but to describe it, and the scope of the technical idea of the present disclosure is not limited by these implementations. The scope of the protection of the present disclosure should be interpreted by the claims below, and all technical ideas within a scope equivalent thereto should be interpreted as being included in the scope of the rights of the present disclosure.

What is claimed is:

1. A method for predicting physical workload in a three-dimensional space based on a monocular image, the method comprising:
processing monocular image data for a body of a human to determine 2-dimensional (2D) pose information of the human;
processing the 2D pose information to determine 3-dimensional (3D) pose information of the human;
applying correcting adjustments to the 3D pose information based on an idle state of the human, using offsets between points in the 3D pose information and reference points for the idle state of the human, to generate corrected 3D pose information; processing the corrected 3D pose information to determine a joint angle for at least one joint in the body of the human; and
predicting the physical workload of the human based on the joint angle for the at least one joint.

2. The method for predicting physical workload of claim 1, wherein the processing of the monocular image data to determine the 2D pose information of the human comprises:
processing the monocular image data using an object detection module to determine detection information for a position and size of the human; and
processing the detection information for the position and size of the human using a pre-trained 2D pose estimation module to determine the 2D pose information of the human.

3. The method for predicting physical workload of claim 2, wherein the processing of the monocular image data using the object detection module to determine the detection information for the position and size of the human comprises:
for each of one or more preset anchor boxes from the monocular image data, determining a probability that the human is present in a space associated with the preset anchor box;
determining a bounding box for the position and size of the human based on the probabilities that the human is present in the spaces associated with the one or more preset anchor boxes; and
determining patch image data for the human based on the bounding box.

4. The method for predicting physical workload of claim 3, wherein the processing of the monocular image data to determine the 2D pose information of the human further comprises:
processing the patch image data for the human to determine 2D position coordinates of the points for the at least one joint.

5. The method for predicting physical workload of claim 4, wherein the processing of the patch image data for the human to determine the 2D position coordinates of the points for at least one joint comprises, for each point:
generating a heat map for the point that related to a probability of a presence of the point within the patch image data; and
determining the 2D position coordinates of the point as the position coordinates at which the point has the highest probability of being present within the patch image data, based on the heat map for the point.

6. The method for predicting physical workload of claim 5, wherein:
the pre-trained 2D pose estimation module is trained using training data obtained by performing principal component analysis of samples from a dataset that includes ground-truth 2D position coordinates of the points.

7. The method for predicting physical workload of claim 6, wherein the processing of the 2D pose information to determine the 3D pose information of the human comprises:
processing the 2D pose information of the human using a pre-trained 3D pose estimation module to determine the 3D pose information of the human,
wherein the pre-trained 3D pose estimation module is trained using training data that includes ground-truth 3D position coordinates of the points that are mapped to the ground-truth 2D position coordinates of the points.

8. The method for predicting physical workload of claim 7, wherein the correcting of the 3D pose information based on the idle state of the human using the offset between the points in the 3D pose information and the reference points for the idle state of the human comprises:
correcting the 3D position coordinates of the points for the at least one joint included in the 3D pose information using an offset from corresponding reference points for the idle state of the human.

9. The method for predicting physical workload of claim 8, wherein the processing of the corrected 3D pose information to determine the joint angle for the at least one joint comprises, for each joint:
calculating the joint angle for the joint using the corrected 3D position coordinates of a point for the joint; and
wherein the predicting of the physical workload of the human based on the joint angle for the at least one joint comprises:
predicting the physical workload based on a musculoskeletal load corresponding to the joint angle for each joint.

10. The method for predicting physical workload of claim 9, wherein the calculating of the joint angle for the joint using the corrected 3D position coordinates of the point for the joint comprises:
determining a plurality of vectors characterizing the joint based on the corrected 3D position coordinates of the point for the joint; and
determining the joint angle for the joint based on a cosine distance for the plurality of vectors.

11. An apparatus for predicting physical workload in a three-dimensional space from a monocular image, the apparatus comprising:
a memory in which a physical workload prediction program is stored; and
a processor configured to load the physical workload prediction program from the memory and execute the physical workload prediction program to perform operations comprising:
processing monocular image data for a body of a human to determine 2D pose information of the human;
processing the 2D pose information to determine 3D pose information of the human;
applying correcting adjustments to the 3D pose information based on an idle state of the human, using offsets between points in the 3D pose information and reference points for the idle state of the human, to generate corrected 3D pose information; processing the corrected 3D pose information to determine a joint angle for at least one joint in the body of the human; and
predicting the physical workload of the human based on the joint angle for the at least one joint.

12. The apparatus for predicting physical workload of claim 11, wherein the processing of the monocular image data to determine the 2D pose information of the human comprises:
processing the monocular image data using an object detection module to determine detection information for a position and size of the human; and
processing the detection information characterizing the position and size of the human using a pre-trained 2D pose estimation module to determine the 2D pose information of the human.

13. The apparatus for predicting physical workload of claim 12, wherein the processing of the monocular image data using the object detection module to determine the detection information for the position and size of the human comprises”
for each of one or more preset anchor boxes from the monocular image data, determining a probability that the human is present in a space associated with the preset anchor box;
determining a bounding box for the position and size of the human based on the probabilities that the human is present in the spaces associated with the one or more preset anchor boxes; and
determine patch image data for the human based on the bounding box.

14. The apparatus for predicting physical workload of claim 13, wherein the processing of the monocular image data to determine the 2D pose information of the human further comprises:
processing the patch image data for the human to determine 2D position coordinates of the points for the at least one joint.

15. The apparatus for predicting physical workload of claim 14, wherein the processing of the patch image data for the human to determine the 2D position coordinates of the points for at least one joint comprises, for each point:
generating a heat map related to a probability of a presence of the point within the patch image data; and
determining the 2D position coordinates of the point as the position coordinates at which the point has the highest probability of being present within the patch image data, based on the heat map for the point.

16. The apparatus for predicting physical workload of claim 15, wherein the processing of the 2D pose information to determine the 3D pose information of the human is performed using a pre-trained 3D pose estimation module.

17. The apparatus for predicting physical workload of claim 16, wherein the correcting of the 3D pose information based on the idle state of the human using the offset between the points in the 3D pose information and the reference points for the idle state of the human comprises:
correcting 3D position coordinates of points for the at least one joint included in the 3D pose information using an offset from a corresponding reference point for the idle state of the human.

18. The apparatus for predicting physical workload of claim 17, wherein the processing of the corrected 3D pose information to determine the joint angle for the at least one joint comprises, for each joint:
calculating the joint angle for the joint using corrected 3D position coordinates of a point for the joint; and
wherein the predicting of the physical workload of the human based on the joint angle for the at least one joint comprises:
predicting the physical workload of the human based on a musculoskeletal load corresponding to the joint angle for each joint.

19. The apparatus for predicting physical workload of claim 18, wherein the calculating of the joint angle for the joint using the corrected 3D position coordinates of the point for the joint comprises:
determining a plurality of vectors characterizing the joint based the corrected 3D position coordinates of the point for the joint; and
determining the joint angle for the joint based on a cosine distance for the plurality of vectors.

20. A non-transitory computer-readable recording medium storing a computer program, wherein
the computer program comprises instructions that, based on being executed by a processor, cause the processor to perform operations of a method for predicting physical workload, the operations comprising:
processing monocular image data for a body of a human to determine 2D pose information of the human;
processing the 2D pose information to determine 3D pose information of the human;
applying correcting adjustments to the 3D pose information based on an idle state of the human, using offsets between points in the 3D pose information and reference points for the idle state of the human, to generate corrected 3D pose information; processing the corrected 3D pose information to determine a joint angle for at least one joint included in the body of the human; and
predicting the physical workload of the human based on the joint angle for the at least one joint.
